(19) United States
(12) Patent Application Publication
(10) Pub. No.: US 2006/0139755 A1
(43) Pub. Date: Jun. 29, 2006

(54) Terahertz time-domain differentiator

(76) Inventors: Roland Kersting, Munich (DE); Aleksey I. Filin, Rensselaer, NY (US); Matthew C. Stowe, Troy, NY (US)

Correspondence Address: RATNERPRESTIA, P O BOX 980, VALLEY FORGE, PA, 19482-0980, US

(21) Appl. No.: 11/224,254

(22) Filed: Sep. 12, 2005

Related U.S. Application Data
(63) Continuation-in-part of application No. 10/487,204, filed on Feb. 18, 2004, now abandoned.
(60) Provisional application No. 60/314,920, filed on Aug. 27, 2001.

(51) Int. Cl. G02B 5/18

(52) U.S. Cl. 359/566

(57) ABSTRACT

A device and method for differentiating an incident electromagnetic pulse. A conductive grating is provided with a sub-wavelength period, an area larger than the electromagnetic beam diameter, and a grating conductor thickness greater than the skin depth of the electromagnetic pulse. The grating conductors are oriented essentially parallel to the incident electromagnetic pulse to diffract the electromagnetic pulse. An aperture captures only the zero-order diffraction of the electromagnetic pulse, which is the first time-derivative of the incident electromagnetic pulse.

### CROSS-REFERENCE TO RELATED APPLICATIONS

This application claims priority of U.S. patent application Ser. No. 10/487,204, filed Feb. 18, 2004, which claimed priority of PCT Application No. US02/20255, filed Jun. 26, 2002, which claimed priority of U.S. Provisional Application No. 60/314,920, filed on Aug. 27, 2001. U.S. patent application Ser. No. 10/487,204, PCT Application No. US02/20255, and U.S. Provisional Application No. 60/314,920 are incorporated by reference herein.

### TECHNICAL FIELD

The present invention is directed generally to a device and method for performing time-domain differentiation of electromagnetic waves and, more particularly, to a device and method for performing time-domain differentiation of electromagnetic pulses in the terahertz frequency range.

### BACKGROUND OF THE INVENTION

The time derivative of an electromagnetic pulse can be obtained using an analog differentiator with an operational amplifier. These analog differentiators are described, for example, by B. Vassos and G. Ewing in “Analog and Computer Electronics for Scientists” (John Wiley and Sons, Inc., 4^{th} ed. 1993). Such differentiators use macroscopic electrical currents and displacement currents.

The bandwidth of analog differentiators using operational amplifiers is limited by the resistance, capacitance, and inductance of the electronic devices used. The bandwidth of the operational amplifier also limits the bandwidth of the analog differentiator. Even integrated resistors, capacitors, and inductors would limit the bandwidth of an analog differentiator using such electronic components to a bandwidth having frequencies in the range of tens of gigahertz.

Diffraction gratings are used in various signal processing applications. For example, U.S. Pat. No. 5,101,297 issued to Yoshida et al. is directed to a method for producing a diffraction grating in optical elements. FIGS. 1a and 1b show an optical wavelength conversion element in which a striped optical wave guide is formed in the middle portion of a substrate comprising a non-linear optical material. Using a sintered target consisting of In₂O₅ mixed with 10% SnO₂, an indium tin oxide (ITO) film is deposited to a thickness of about 0.1 micrometers as a transparent conductive film on a substrate including the optical wave guide. Polymethyl methacrylate (PMMA) film is formed and cured on the ITO film as an electron beam resist film. A diffraction pattern is drawn on the PMMA film with an electron beam, and the PMMA film is developed to form the diffraction grating. Yoshida et al. suggest using the disclosed diffraction grating for optical coupling. In another example, U.S. Pat. No. 6,031,243 issued to Taylor is directed to a vertical cavity opto-electronic device using a blazed grating to couple electromagnetic waves.

In U.S. Pat. No. 5,953,161 issued to Troxell et al., a diffraction grating array is used in an infra-red (1R) imaging system. The diffraction grating is used in an active state to diffract IR radiation of the pre-determined IR wavelength at a pre-determined angle to strike an IR detector. In an inactive state, the diffraction grating does not diffract IR radiation of the pre-determined wavelength at the pre-determined angle. The diffraction grating has a plurality of parallel bars of constant width, the width of each bar being on the order of one-half the pitch between adjacent bars. Each bar is suspended over and parallel to a substrate. The bars are provided with an optically reflective and electrically conductive coating, with a similar coating on the substrate below the bars. The diffraction grating is switched to an active state by applying a voltage potential to deform the bars.

A published article by A. Churpin et al., “Phase Characteristics of Thick Metal Grating,” Proc. Microwave Antennas Propog. 145, 411 (1998), is directed to setting the periodicity (<<λ) of a thick metal grating to provide frequency and incident angle independence for reflected and transmitted coefficient phases of E-polarized transmissions at frequencies <20 GHz. The article suggests that such gratings may be useful in building polarization rotators and power dividers. Disclosed is a ninety-degree phase shift for transmitted waves when the reference plane coincides with the symmetry plane of the grating conductors.

Another published article by J. White et al., “Response of Grating Pairs to Single-Cycle Electromagnetic Pulses,” J. Opt. Soc. Am., Vol. 12, No. 9, p. 1687 (September 1995), is directed to time-domain pulse shaping with diffraction gratings and presents experimental time-resolved data for various gratings. Yet another published article by K. Wynne and D. Jaroszynski, “Superluminal Terahertz Pulses,” Optics Letters, Vol. 24, No. 1 (January 1999), is directed to time-resolved experiments of terahertz pulses transmitted through a silicon-on-sapphire chip, showing superluminal transport.

Although analog time domain differentiators using operational amplifiers are known, a need exists for a time-domain differentiator that can operate in the terahertz frequency range, and that can provide an adequate operational bandwidth.

### SUMMARY OF THE INVENTION

To meet these and other needs, and in view of its purposes, an exemplary embodiment of the present invention provides a device and method for differentiating an incident electromagnetic pulse. A conductive grating is provided with a sub-wavelength period, an area larger than the electromagnetic beam diameter, and a grating conductor thickness greater than the skin depth of the electromagnetic pulse. The grating conductors are oriented essentially parallel to the incident electromagnetic pulse to diffract the electromagnetic pulse. An aperture captures only the zero-order diffraction of the electromagnetic pulse which is the first time derivative of the incident electromagnetic pulse.

It is to be understood that both the foregoing general description and the following detailed description are exemplary, but are not restrictive, of the invention.

### BRIEF DESCRIPTION OF THE DRAWING

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 is a diffraction grating according to an exemplary embodiment of the invention;

FIG. 2 is a sectional view of the diffraction grating of FIG. 1 taken generally along the line 2-2;

FIG. 3 shows an incident electromagnetic signal being diffracted by a diffraction grating according to an exemplary embodiment of the invention;

FIG. 4 shows a time-domain differentiator according to an exemplary embodiment of the invention; and

FIGS. 5A and 5B respectively show measurement data for perpendicular polarized and parallel polarized pulses incident on an exemplary time-domain differentiator of FIG. 4 and the corresponding output pulses from the time-domain differentiator;

FIG. 6A shows temporal measurement data for a pulse incident on an exemplary time-domain differentiator of FIG. 4, the output pulse from the time-domain differentiator, and the calculated derivative of the incident pulse;

FIG. 6B shows spectral measurement data for a pulse incident on an exemplary time-domain differentiator of FIG. 4, the output pulse from the time-domain differentiator, and the calculated derivative of the incident pulse; and

FIG. 7 shows measurement data for exemplary output pulses from exemplary time-domain differentiator of FIG. 4 and calculated transmission transients of a test pulse for several grating periods.

### DETAILED DESCRIPTION OF THE INVENTION

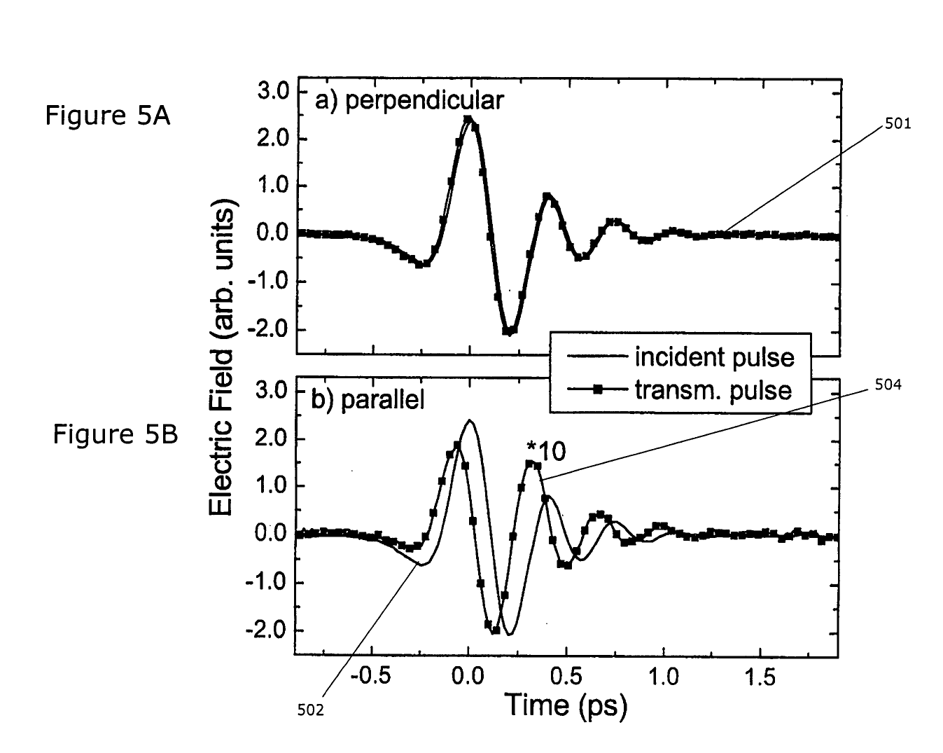

Exemplary embodiments of the present invention include methods and apparatus to accomplish the time-domain differentiation of light waves by metallic transmission gratings. Time-resolved THz experiments performed by the inventors (and described below with reference to FIGS. 5A, 5B, 6A, 6B, and 7) demonstrate that analog computation of the first time derivative of an arbitrary waveform may be achieved using gratings having a sub-wavelength period. These results are in accord with classical electromagnetic grating theory and may enable novel applications in spectroscopy and ultrahigh frequency optoelectronics.

The control of light by modifying either its spectral distribution or its temporal shape is a prime issue of optics. Periodic structures, such as gratings, have long been used as tools for the control of light. The development of more advanced structures, such as photonic band-gaps, has stimulated increased efforts to understand the transmission and reflection of sub-wavelength structures. In the case of metallic structures, light transmission may be constrained when the dimension of the apertures becomes comparable to the wavelength of the incident light or even smaller as described by H. Bethe (Phys. Rev. 66, 163 (1944)). Recent advances on the study of the interaction of electromagnetic radiation with submicron metallic structures, such as, for example: articles by T. Ebbesen, H. Lezec, H. Ghaemi, T. Thio, and P. Wolff (Nature 391, 667 (1998)); L. Martin-Moreno, F. Garcia-Vidal, H. Lezec, K. Pellerin, T. Thio, J. Pendry, and T. Ebbesen (Phys. Rev. Lett. 86, 1114 (2001); and L. Salomon, F. Grillot, A. Zayats, and F. de Formel (Phys. Rev. Lett. 86, 1110 (2001)), have shown that increased transmission through these structures may be achieved by coupling the light to surface plasmon resonances on the metallic structures.

Most research on periodic metallic structures has focused on spectral transmission or reflection. Thus, although gratings have been used for time-domain pulse shaping for decades in applications, such as those described by E. Tracey (IEEE J. Quant. Electr. 5, 454 (1969)), the effects of gratings that occur on a sub-cycle time scale are not as well known due to a lack of experiments in which measurements have been taken with the required time resolution to observe these effects. The first time-resolved experiments addressing such properties were performed by K. Wynne and D. Jaroszynski (Opt. Lett. 24, 25 (1999)) at THz frequencies. K. Wynne et al. interpreted the results of these experiments in terms of superluminal transport through sub-wavelength structures.

The inventors of the present invention have performed a time-resolved study of light transmission through metallic gratings. These experiments were performed using terahertz time-domain spectroscopy (THz-TDS). The femtosecond time resolution of this technique allowed for the observation of sub-cycle changes of the light that was transmitted through the exemplary gratings. It was found that the electric field of the zero-order transmission signal is the first time derivative of the electric field of the incident light. As discussed in detail below, classical electromagnetic diffraction theory confirms these experimental findings and shows the scale invariance of this analog time differentiation of light.

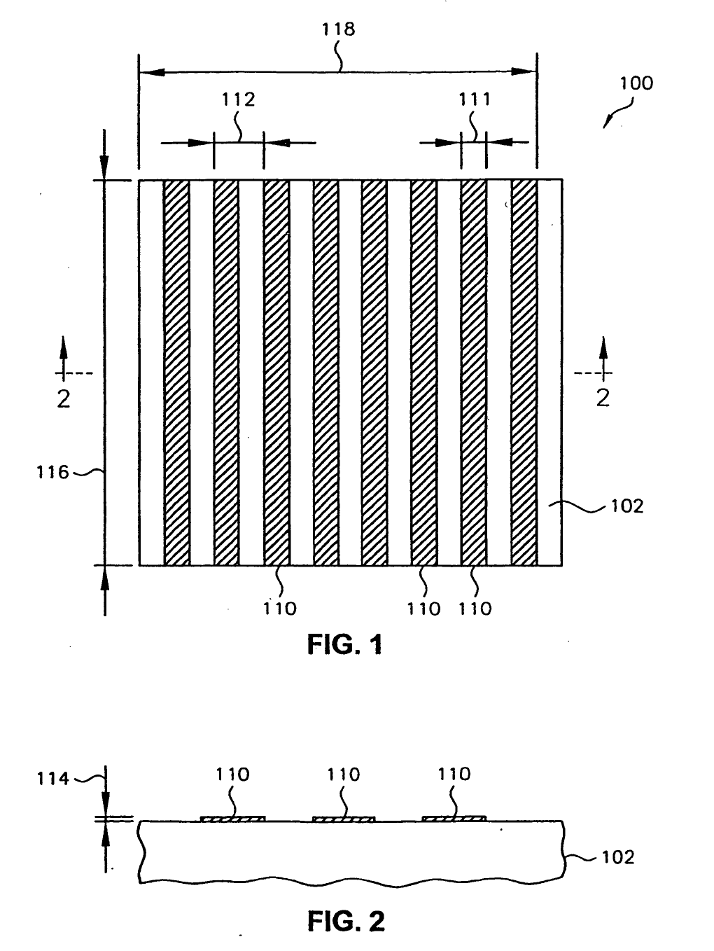

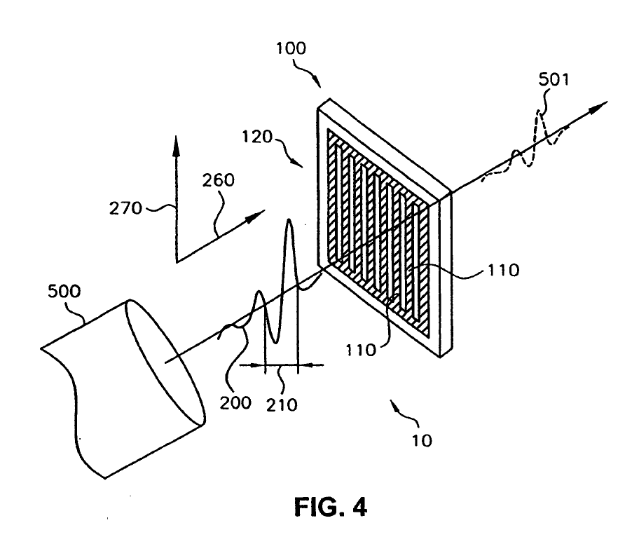

Referring now to the drawing, in which like reference numbers refer to like elements throughout, FIGS. 1 and 2 show a diffraction grating 100 for use in a time-domain differentiator according to an exemplary embodiment of the present invention. Grating 100 comprises a plurality of parallel conductors 110, formed on an optically transparent substrate 102. Conductors 110 are sized to correspond to physical parameters of an incident input signal 200 (shown in FIG. 4) and, more particularly, to the wavelength (A) 210.

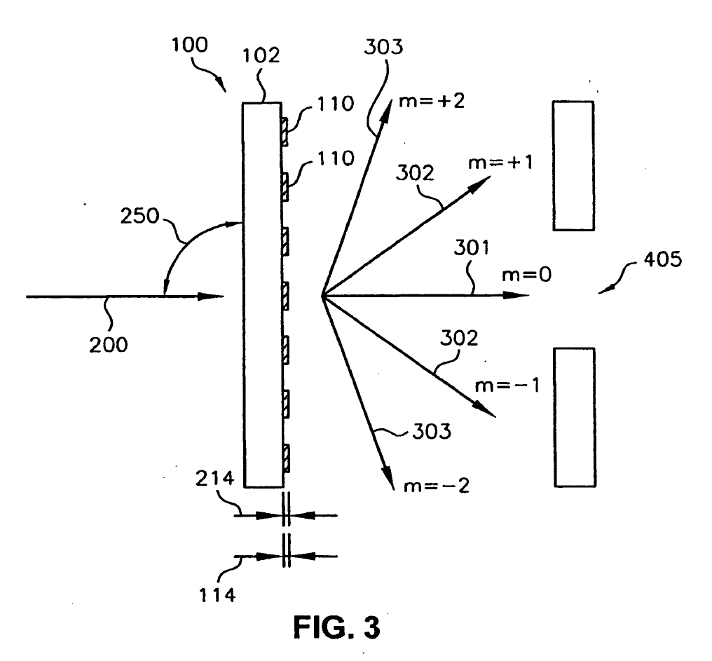

Conductors 110 each have a width 111 and period 112 (the distance from the beginning of one conductor to the beginning of the next conductor). Width 111 is about one-half of period 112, and period 112 is less than the wavelength 210 of incident input signal 200. Conductors 110 have a thickness 114 greater than the skin depth 214 (shown in FIG. 3) of incident input signal 200 in the conductors. Skin depth 214 of incident input signal 200 in conductors 110 is the depth that incident input signal 200 will penetrate into conductors 110, and is determined by the frequency of incident input signal 200 and the material comprising conductors 110. Thickness 114 is greater than skin depth 214 so that incident input signal 200 is diffracted by, and does not penetrate, conductors 110.

Conductors 110 may comprise any of a variety of conductive materials, including, but not limited to, gold (Au). Grating 100 may be formed, for example, by selective metal deposition or by patterning a blanket deposition layer such as with e-beam evaporation. Substrate 102 may be, for example, a silicon wafer or Mylar® foil. Conductors 110 (and grating 100) have a longitudinal length 116 which is greater than wavelength 210. Grating 100 has a width 118 equal to period 112 multiplied by the number of conductors 110. Diffraction grating 100 has an area equal to longitudinal length 116 multiplied by width 118. The area is sufficient to cover incident input signal 200.

In an exemplary embodiment of the invention, as shown in FIG. 3, diffraction grating 100 is disposed to diffract incident input signal 200 (i.e., an electromagnetic wave). Conductors 110 are oriented essentially parallel to incident input signal 200. Incident input signal 200 enters diffraction grating 100 at an incident angle 250 of about ninety (90) degrees to width 118 of diffraction grating 100. Incident input signal 200 is diffracted by diffraction grating 100 into zero-order diffraction signal 301, first order diffraction signals 302, second order diffraction signals 303, and lower order diffraction signals (not shown). An aperture 405 is disposed in the path of the diffraction signals to transmit only zero-order diffraction signal 301, which is the time-domain derivative of incident input signal 200, as an output signal.

The transmission of electromagnetic radiation through gratings having a sub-wavelength period is strongly dependent on the orientation of the grating lines relative to the polarization vector of the incident electric field of the THz pulse.

FIG. 5 illustrates the transmission of a few-cycle THz pulse through an exemplary grating compared to the incident pulse. The incident pulses were recorded by transmitting the THz pulse through a bare silicon wafer. FIG. 5A shows measured incident and transmission data 501 for the case of perpendicular orientation between the polarization vector of the incident pulse and the grating lines. As expected, the THz pulses are nearly perfectly transmitted through the grating. Both amplitude and phase of the incident light are preserved.

However, in the present invention, the case in which the grating lines have a parallel orientation with respect to the electric field of the incident light is of greatest interest. FIG. 5B illustrates experimental incident pulse data 502 and transmitted pulse data 504 for this case. It is noted that the field amplitude of transmitted pulse data 504 is significantly reduced in this orientation. (It is shown enlarged by a factor of 10 in FIG. 5B). Moreover, the transmitted pulse may appear to arrive earlier than a pulse transmitted through a reference wafer without grating. However, a detailed analysis of both the leading edge and the centroid of transmitted pulse 504 shows that no superluminal propagation has occurred, in contrast to the case described by K. Wynne et al.

A closer look at FIG. 5B suggests an alternative interpretation: the extrema of transmission signal 504 correspond to the inflection points of incident pulse 502, which indicates that transmission signal 504 is the first derivative of incident pulse 502. These findings have been confirmed by a numerical calculation of the time derivative ωl/c as a scaling factor, where ω is the peak frequency of the incident pulse l is a scaled length equal to the grating period times (ln 2)/n and c is the speed of light. (This scaling factor may be deduced below from Eq. 6.)

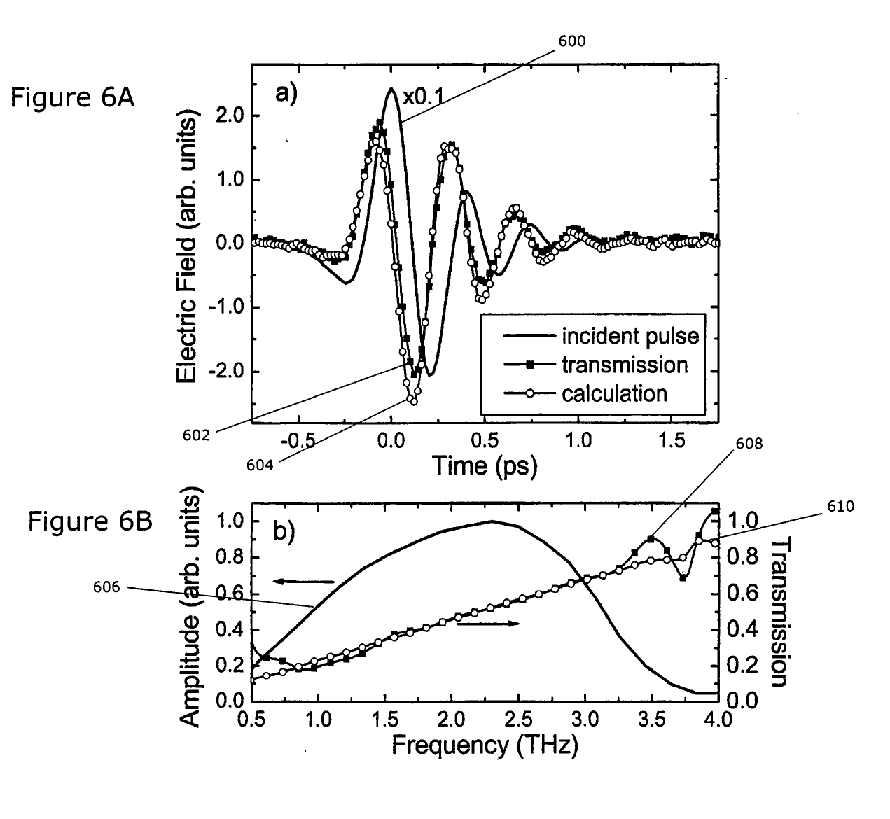

FIGS. 6A and 6B illustrate an exemplary comparison between such a calculation and measured experimental data. FIG. 6A includes incident THz pulse 600, measured transmission signal 602, and calculated time-derivative 604 of the incident pulse in time-domain. Transmission signal 602 was recorded on a grating of 10 μm period. The signal of the incident pulse is scaled by a factor of 0.1. FIG. 6B includes amplitude spectra 606 of the incident THz pulse 600, transmission spectra 608 of the measured transmission signal 602, and transmission spectra 610 of calculated time-derivative 604 of the incident pulse. As illustrated in FIG. 6B, the amplitude spectra of the calculated and measured transmissions indicate a good agreement over a broad frequency range extending between about 0.75 THz and about 3.50 THz.

To achieve a quantitative insight into the observed phenomena, the transmission may be calculated in the time-domain. In general, the transmission properties are well understood for two extreme relations between the grating period, d, of the grating and wavelength, λ, of the incident light: i) If d/λ→0, the grating becomes a homogeneous metallic sheet. As a result, the transmission of the grating is zero and the reflected wave is, assuming perfect conductivity, the second derivative of the incident signal. ii) if d/λ→∞, perfect transmission occurs for light propagating through the gaps of the grating. For grating periods comparable to the wavelength, one has to consider the diffraction properties of periodic structures. In the following an electromagnetic wave which is polarized in the x-direction is considered:

$${E}_{x}^{inc} = {\int }_{0}^{∞} E ( k ) exp \{ i ( kz - ω t ) \} ⅆ k + c . c . \qquad ( 1 )$$

The wave impinges on a grating with a filling factor of 0.5, which is placed at and oriented along the x-direction. According to classical diffraction theory as described in THE THEORY OF DIFFRACTION AND THE FACTORIZATION METHOD by L. Weinstein, The Golem Press (1969)), the reflected and transmitted waves are:

$${E}_{x} = exp ( ikz ) + {\sum }_{n = - ∞}^{∞} {A}_{n} exp \{ ik ( y sin {ϕ}_{n} - z cos {ϕ}_{n} ) \} for z < 0 \\ {E}_{x} = {\sum }_{n = - ∞}^{∞} {B}_{n} exp \{ ik ( y sin {ϕ}_{n} + z cos {ϕ}_{n} ) \} for z > 0 \qquad ( 2 )$$

where n is the order of diffraction, sin φₙ=nλ/2d, and cos φₙ=\sqrt{1−(nλ2d)²}. Restricting the discussion here to the zero-order diffraction, which corresponds to exemplary embodiments of the present invention, and continuing with classical diffraction theory as described by L. Weinstein, the remaining coefficients for the reflected and transmitted waves are:

$${A}_{0} ( k ) = \frac{- 1}{1 - ikl} ; {B}_{0} ( k ) = \frac{- ikl}{1 - ikl} \qquad ( 3 )$$

where l=(d ln 2)/n. This yields the transmitted wave:

$${E}_{x}^{tr} = {\int }_{0}^{∞} {B}_{0} ( k ) E ( k ) exp \{ i ( kz - ω t ) \} ⅆ k + c . c . \qquad ( 4 )$$

Taking into account that kl=(2d ln 2)/λ<<1, an expansion up to fourth order in kl gives:

$$\begin{matrix}{E}_{x}^{tr} = 2 {\int }_{0}^{∞} ( kl - {k}^{3} {l}^{3} ) sin ( kz - ω t ) E ( k ) ⅆ k + 2 {\int }_{0}^{∞} ( {k}^{2} {l}^{2} - {k}^{4} {l}^{4} ) cos ( kz - ω t ) E ( k ) ⅆ k & ( 5 ) \\ = \frac{ω l}{c} \frac{\partial }{\partial ( ω t )} {E}_{x}^{inc} - {( \frac{ω l}{c} )}^{2} \frac{{\partial }^{2}}{\partial {( ω t )}^{2}} {E}_{x}^{inc} + {( \frac{ω l}{c} )}^{3} \frac{{\partial }^{3}}{\partial {( ω t )}^{3}} {E}_{x}^{inc} - {( \frac{ω l}{c} )}^{4} \frac{{\partial }^{4}}{\partial {( ω t )}^{4}} {E}_{x}^{inc} & ( 6 )\end{matrix}$$

In the experiments illustrated in FIGS. 5A, 5B, 6A, 6B, and 7, the grating period is much smaller than the wavelength. Thus, ωl/c=(2d ln 2)/λ<<1. For this condition only the first term in Eq. 6 is significant, and the transmitted signal may be estimated to be the time derivative of the incident wave. This confirms the good agreement between experimental data and the numerically calculated first derivative shown in FIG. 6.

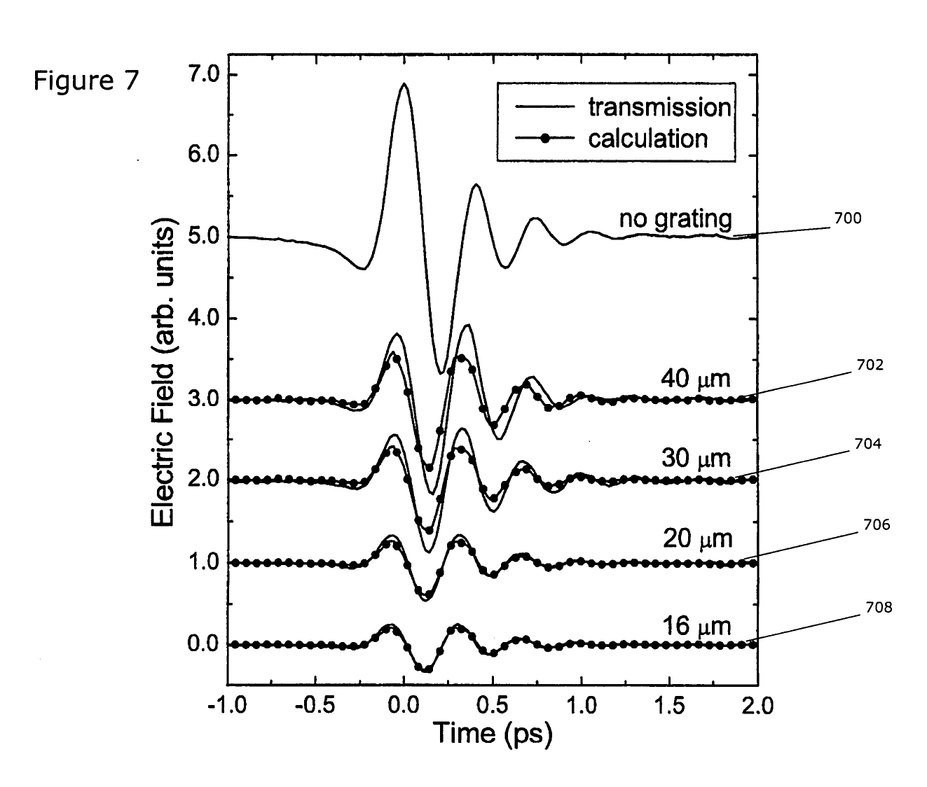

FIG. 7 shows an evaluation of the transmitted signal for several grating periods using Eq. (6). Transmitted signal 700 corresponds to transmission through a substrate with no grating). Transmitted signal 702 corresponds to transmission through a grating with a grating period of 40 μm. Transmitted signal 704 corresponds to transmission through a grating with a grating period of 30 μm. Transmitted signal 706 corresponds to transmission through a grating with a grating period of 20 μm. Transmitted signal 708 corresponds to transmission through a grating with a grating period of 16 μm.

A good agreement between experimental data and calculation is shown in FIG. 7, in particular for small grating periods, i.e. as the transmission signal becomes closer to the first derivative of the incident pulse. Increasing the grating period with respect to the wavelength is equivalent to increasing ωl/c in Eq. 6, leading to the contributions of higher orders to the transmission signal. In general, a good approximation of the first derivative may be achieved for grating periods much smaller than the wavelength of the incident light. For instance d/λ=0.02 reduces higher order contributions to less than 3%. However, the transmitted field intensity is significantly reduced at such small periodicities as shown in FIGS. 6A and 7.

It is noted that time-domain differentiation of light waves is not limited to radiation having THz frequencies. The above findings are scale invariant. Time-domain differentiation may also occur when transmitting visible or near infrared light through perfectly, or near perfectly, conducting sub-wavelength structures or through stacks which form photonic bandgaps. Moreover, as shown in FIG. 6B, the spectral range within which a first order derivative may be achieved is quite broad (particularly when transforming this frequency interval to the visible). Within this frequency interval, time-domain derivatives of light fields may be achieved not only for pulse shapes as discussed here but also for arbitrary transients. This property may enable novel applications. In spectroscopy, time-domain differentiation exchanges the real and imaginary constituents of the field and leads to changes in the signatures of a measured dielectric function. Other potential applications are in the emerging field of THz optoelectronics where an analog differentiator may enrich the palette of available ultrahigh speed devices such as filters, pulse shapers, and modulators.

The present invention provides time-domain differentiation of an input signal provided as an optical electromagnetic wave instead of an electrical current as in existing differentiators. Differentiation of optical waves provides differentiation of signals having frequencies in the terahertz range. Such frequencies may be desirable to facilitate a number of modern high-speed signal processing applications.

In an exemplary embodiment of the invention, incident input signal 200 has a center frequency with frequency variation. Wavelength 210 is the inverse of the center frequency. Period 112 of diffraction grating 100 is less than wavelength 210 divided by the product of two and the natural log of two. In this exemplary embodiment, diffraction grating 100 provides a spectral operational frequency range of between about 0.3 and 1.5 times the center frequency. This spectral range is significantly greater than the spectral range for electronic current differentiators.

Referring now to FIG. 4, a time-domain differentiator 10 is provided. Time-domain differentiator 10 comprises grating 100 having a grating face 120 with an area greater than the beam diameter of the electromagnetic pulse (incident input signal 200) to be differentiated. The beam diameter is the area covered by the pulse perpendicular to the direction of propagation 260 of incident input signal 200. Grating 100 is disposed to receive the pulse incident grating face 120 and to diffract the pulse.

A signal source 500 provides incident input signal 200 (i.e., an electromagnetic wave) to grating 100. Incident input signal 200 has a wavelength 210, a skin depth 214 (shown in FIG. 3) in conductors 110 of grating 100, and a beam diameter (not shown). Incident input signal 200 is polarized by, for example, an electric field 270 generally perpendicular to direction of propagation 260 and parallel with conductors 110. Electric field 270 orients incident input signal 200 generally along longitudinal length 116 (shown in FIG. 1) of conductors 110.

Output terahertz pulse 501 (based on zero-order diffraction) propagates from diffraction grating 100 opposite grating face 120 in direction of propagation 260. Aperture 405 (shown in FIG. 3) captures only output pulse 501 which may be transmitted through a fiber optic cable, waveguide, or the like. Output pulse 501 is the time domain derivative of incident input signal 200. Output pulse 501 (i.e., time-domain derivative) may be useful in a variety of signal-processing applications, including but not limited to: precise triggering of ultrafast signals due to its very sharp signal peaks, markers for use in jitter reduction algorithms, precision clock signals, and exchange of real and imaginary portions of dielectric response function for use in spectroscopy.

Referring again to FIGS. 3, 4, and 6A, an incident input pulse 600 (corresponding to exemplary pulse 200 in FIGS. 3 and 4) having a frequency of about 2 terahertz may be provided to various exemplary time-domain differentiators 10 as described above with reference to FIG. 4. Time-domain differentiators 10 comprise a 10 mm by 10 mm gold grating 100 having a period of from 10 to 40 micrometers and a filling factor of about 50% (i.e., conductor width 111 is one-half of period 112). Thickness 114 is about 200 nm which is substantially greater than the skin depth in gold at 1 THz (approximately 30 nm). Incident input pulse 600 is generated by excitation of an n-doped InAs crystal with 70 fs laser pulses of 770 nm wavelength and 5 nJ pulse energy. The center frequency of input pulse 600 is about 2.25 THz, which corresponds to a wavelength of about 130 micrometers. As shown in FIG. 3, an aperture 405 captures only the zero-order diffraction 301 from grating 100. Incident input pulse 600 and output pulse 602 (corresponding to exemplary pulse 301 in FIG. 3 and exemplary pulse 501 in FIG. 4) were measured using terahertz time-domain spectroscopy (THz-TDS) and theoretical output signal 604 was calculated. As shown in FIG. 6A, measured output pulse 602 from time domain differentiator 10 shows very good correlation with theoretical output signal 604 which is the time-domain derivative of incident input pulse 600.

In an exemplary embodiment of the invention, a method is provided for performing a time-domain differentiation of an electromagnetic pulse. An electromagnetic pulse (or range of pulses) that is to be differentiated is identified. For example, a wavelength, a center frequency, a skin depth in a conductor, and a beam diameter for the pulse is determined. A diffraction grating is provided comprising spaced parallel conductive lines composed of the conductor and having a period less than the wavelength, a thickness greater than the skin depth, an area greater than the beam diameter, and a length greater than the wavelength. The diffraction grating is oriented such that the electromagnetic pulse is incident to the diffraction grating and aligned with the conductive lines. Only the zero-order diffraction of the incident electromagnetic pulse is captured, which is the time-domain derivative of the input pulse.

Metallic transmission gratings were fabricated on semi-insulating silicon by E-beam evaporation. The 10 mm×10 mm gold gratings have periods between 10 μm and 40 μm and a filling factor of 50%. The 200 nm metal films are significantly thicker than the skin depth of gold, which is approximately 30 nm at 1 THz. We measured the transmission through the gratings by free-space THz-TDS. Coherent THz pulses are generated by the excitation of an n-doped InAs crystal with 70 fs laser pulses of 770 nm wavelength and 5 nJ pulse energy. The center frequency of the THz pulses is about 2.25 THz, which corresponds to a wavelength of about 130 μm. The transmitted pulses are detected in the time-domain using the electro-optic sampling method. The detection bandwidth of the setup is limited by the 300 μm thick Zn Te crystal to about 3.5 THz. Only the zero-order diffraction of the transmission is detected. The aperture of the setup prevents higher orders from contributing to the signal. To avoid spectroscopic artifacts due to water absorption, the experiments are performed in a vacuum chamber at 0.1 mbar.

Although illustrated and described above with reference to certain specific embodiments, the present invention is nevertheless not intended to be limited to the details shown. Rather, various modifications may be made in the details within the scope and range of equivalents of the claims and without departing from the invention.

What is claimed:

1. A time-domain differentiator comprising:
a signal source providing a polarized input electromagnetic wave having a wavelength, a skin depth, a polarization vector, and a beam diameter;
a transmission grating having a grating face with an area greater than the beam diameter and disposed to receive the polarized input electromagnetic wave incident the grating face and diffract the polarized input electromagnetic wave, providing a zero-order diffraction, the grating face comprising parallel conductors having a period less than the wavelength and a thickness greater than the skin depth, the conductors being oriented essentially parallel to the polarization vector of the polarized input electromagnetic wave; and
an aperture sized and positioned to capture only the zero-order diffraction of the diffracted polarized input electromagnetic wave, the zero-order diffraction being an electromagnetic wave essentially equivalent to a time-domain derivative of the polarized input electromagnetic wave.

2. The time-domain differentiator of claim 1 wherein the electromagnetic wave has a frequency of greater than one terahertz.

3. The time-domain differentiator of claim 1 wherein the conductors comprise a pattern of metal lines formed on a transparent substrate.

4. The time-domain differentiator of claim 1 wherein the time-domain derivative is provided without using an electrical current.

5. The time-domain differentiator of claim 1 wherein the period is less than the wavelength divided by the product of two and the natural log of two.

6. The time-domain differentiator of claim 5 wherein the incident polarized input electromagnetic wave comprises pulses having a center frequency corresponding to the wavelength, and the grating provides a spectral operational frequency range of between about 0.3 and 1.5 times the center frequency.

7. A method for performing a time-domain differentiation of an electromagnetic pulse, comprising:
identifying an electromagnetic pulse to be differentiated, the pulse having a wavelength, a center frequency, a skin depth in a conductor, a polarization vector, and a beam diameter;
providing a transmission diffraction grating having an area greater that the beam diameter, the diffraction grating comprising spaced parallel conductive lines composed of the conductor, the conductive lines having:
a period less than the wavelength;
a thickness greater than the skin depth; and
a longitudinal length greater than the wavelength;
orienting the diffraction grating such that the electromagnetic pulse is incident to the diffraction grating and the polarization vector of the electromagnetic pulse is aligned with the conductive lines; and
capturing only the zero-order diffraction of the incident electromagnetic pulse.

8. The method of claim 7 wherein the electromagnetic pulse has a frequency of greater than one terahertz.

9. The method of claim 7 wherein the conductors comprise a pattern of metal lines formed on a transparent substrate.

10. The method of claim 7 wherein the time-domain derivative is provided without using an electrical current.

11. The method of claim 7 wherein the period is less than the wavelength divided by the product of two and the natural log of two.

12. The method of claim 11 wherein the incident electromagnetic pulse comprises pulses having a center frequency corresponding to the wavelength, and the grating provides a spectral operational frequency range of between about 0.3 and 1.5 times the center frequency.
